(19) United States
(12) Patent Application Publication
(10) Pub. No.: US 2026/0281057 A1
(43) Pub. Date: Sep. 17, 2026

(54) APPLICATION LEVEL QUALITY OF SERVICE CONTROL

(71) Applicant: Telefonaktiebolaget LM Ericsson (publ), Stockholm (SE)

(72) Inventors: Heikki MAHKONEN, Redondo Beach, CA (US); Wassim Michel HADDAD, San Jose, CA (US); Lusheng JI, Los Angeles, CA (US); Alec EMMONS, Los Angeles, CA (US); Yury SHEFER, Redondo Beach, CA (US)

(73) Assignee: Telefonaktiebolaget LM Ericsson (publ), Stockholm (SE)

(21) Appl. No.: 19/474,439

(22) PCT Filed: Apr. 12, 2023
(86) PCT No.: PCT/IB2023/053758

§ 371 Date: Oct. 10, 2025

(51) Int. Cl. H04L 47/80; H04L 47/70

(52) U.S. Cl. CPC H04L 47/805; H04L 47/825

(57) ABSTRACT

A method performed by a client device is provided. The method comprises transmitting to a quality of service, QoS, control entity a first request for a first QoS level. The method further comprises, after transmitting the first request, receiving from the QoS control entity a first response that includes first tunnel information of a first tunnel configured by the QoS control entity. The first tunnel is for carrying data packets of the first QoS level in a wireless network.

### TECHNICAL FIELD

This disclosure relates to application level Quality of Service (QoS) control.

### BACKGROUND

Third Generation Partnership Project (3GPP) provides dynamic QoS control over Communication Service Provider's (CSP) cellular access networks for user applications. More specifically, CSPs provide cellular network QoS level control function to external service(s) called Service Capability Server (SCS).

In order for the SCS to be able to control the cellular network QoS levels for different applications, it is required that the SCS has the knowledge of which application data packet corresponds to which application. Such knowledge allows the SCS to apply QoS level control to a particular application data packet corresponding to a particular application for which the SCS wants to improve the QoS level.

To obtain such knowledge, i.e., to identify the mapping between the particular application data packet and the particular application, the SCS needs to have the visibility to the information of the application data packet (e.g., the destination address of the application data flow).

### SUMMARY

However, certain challenges presently exist. For example, the way QoS level control (a.k.a., “QoS control”) has been provided in the current 3GPP architecture for the SCS makes the QoS control complicated. This architecture requires the SCS to know IP packet information (e.g., the destination addresses) about application data packets in advance and configure the QoS control for the application data packets based on such information. However, these application data packets are highly dynamic in nature, and thus it is difficult to know this information (e.g., the destination addresses) about the application data packets in advance. Using packet inspection techniques such as Deep Packet Inspection (DPI) may allow obtaining such information about the application packets. But this may not work in all circumstances. For example, many applications today use end-to-end (E2E) encryption which limits the DPI's visibility of the information about the application data packets.

Another challenge is the maximum amount of traffic policy rules (e.g., traffic flow template (TFT)) that the 3GPP network allows per dedicated bearer. Modern mobile applications can be highly complex. They may require dozens or even hundreds of logical connections. Currently, the maximum number of the policy rules per dedicated bearer is 8. This means that only a small number of applications can share a single dedicated bearer until the traffic policy rules are exhausted. To solve this problem, more dedicated bearers can be configured by the CSP for additional applications. But this may require the CSP to configure those additional applications into the network beforehand, thereby making the management of the QoS control in a CSP network complex and difficult, not to mention that how many dedicated bearers can be set up for each user equipment (UE) is also limited.

Therefore, there is a need to provide application level QoS control without requiring visibility to the information (e.g., the 5-tuples) about application data packets.

Accordingly, in some embodiments of this disclosure, there is provided a method performed by a client device. The method comprises transmitting to a quality of service, QoS, control entity a first request for a first QoS level. The method further comprises, after transmitting the first request, receiving from the QoS control entity a first response that includes first tunnel information of a first tunnel configured by the QoS control entity, wherein the first tunnel is for carrying data packets of the first QoS level in a wireless network.

In another aspect, there is provided a method performed by a quality of service, QoS, control entity. The method comprises receiving from a client device a first request for a first QoS level. The method further comprises, after receiving the first request, configuring a first tunnel for carrying data packets of the first QoS level in a wireless network. The method further comprises, transmitting to the client device a first response that includes first tunnel information of the first tunnel.

In another aspect, there is provided a computer program comprising instructions which when executed by processing circuitry cause the processing circuitry to perform the method of at least one of the embodiments described above.

In another aspect, there is provided a client device. The client device is configured to transmit to a quality of service, QoS, control entity a first request for a first QoS level. The client device is further configured to, after transmitting the first request, receive from the QoS control entity a first response that includes first tunnel information of a first tunnel configured by the QoS control entity, wherein the first tunnel is for carrying data packets of the first QoS level in a wireless network.

In another aspect, there is provided a quality of service, QoS, control entity. The QoS control entity is configured to receive from a client device a first request for a first QoS level. The QoS control entity is further configured to, after receiving the first request, configure a first tunnel for carrying data packets of the first QoS level in a wireless network. The QoS control entity is further configured to transmit to the client device a first response that includes first tunnel information of the first tunnel.

According to some embodiments of this disclosure, the QoS traffic flow rules are not tied to individual applications, and thus the number of required QoS traffic flow rules can be reduced substantially. This also makes it easier to configure different QoS levels for a CSP in the network as the number of applications that are supported do not impact the QoS or bearer configurations. More specifically, in some embodiments, CSPs can configure different levels of service in the network and a QoS controller can select from these levels when orchestrating the overlays and configuring TFTs for them. In addition, some embodiments of this disclosure enable service level agreements with service providers where the overlay gateway (GW) can be orchestrated in the best possible place in the network edge or even within a service provider's network to allow the best possible E2E QoS levels.

### BRIEF DESCRIPTION OF THE DRAWINGS

The accompanying drawings, which are incorporated herein and form part of the specification, illustrate various embodiments.

FIG. 1 shows an exemplary scenario where some embodiments of this disclosure can be implemented.

FIG. 2A shows an exemplary flow.

FIG. 2B shows an exemplary overlay.

FIG. 3 shows a process according to some embodiments.

FIG. 4 shows an exemplary configuration of overlays.

FIG. 5 shows an exemplary configuration of overlays.

FIG. 6 shows an exemplary configuration of overlays.

FIG. 7A shows a flow chart according to some embodiments.

FIG. 7B shows a flow chart according to some embodiments.

FIG. 7C shows a flow chart according to some embodiments.

FIG. 8 shows a process according to some embodiments.

FIG. 9 shows a process according to some embodiments.

FIG. 10 shows an apparatus according to some embodiments.

FIG. 11 shows an apparatus according to some embodiments.

### DETAILED DESCRIPTION

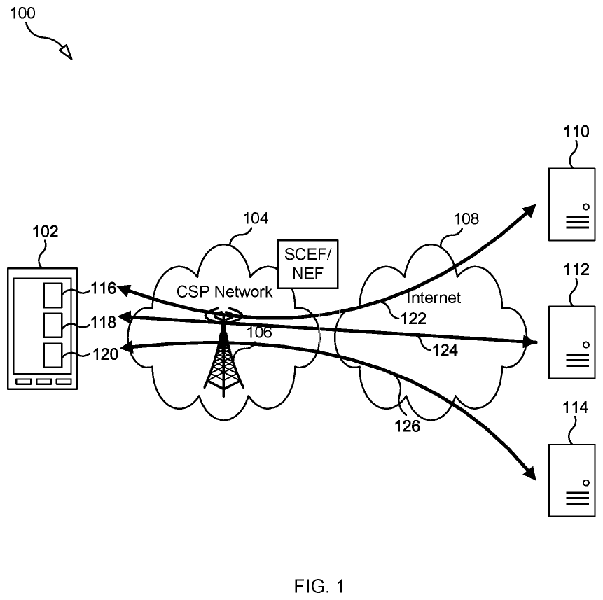

FIG. 1 shows an exemplary scenario 100 where some embodiments of this disclosure can be implemented. In the scenario 100, a client device (a.k.a., “user equipment” or “UE”) 102 is connected to a wireless network 104 (a.k.a., “CSP network”) provided by a base station (e.g., gNB) 106. Examples of the client device 102 include a mobile phone, a tablet, a laptop, an Internet of Things (IoT) device, a vehicle, a computer, a router, etc. Via the wireless network 104, the client device 102 is connected to internet 108, and via the internet 108, the client device 102 is connected to service network nodes (herein after, “NNs”) 110, 112, and 114.

Each of the service NNs (e.g., servers) 110, 112, and 114 is configured to provide a service to the client device 102 via an application (a.k.a., “app”) 116, 118, or 120 running on the client device 102. In one example, the service NN 110 is a video streaming server, and the app 116 is a video streaming app. In another example, the service NN 112 is a social network server, and the app 118 is a social network app. In further example, the service NN 114 is a navigation map server, and the app 120 is a navigation map app.

Data packets for a particular app travel from the client device 102 to a service NN (or vice versa) by Internet routing infrastructure. Typically, a data packet travels between the client device and a NN via a logical connection often known as traffic flow or flow. A flow may be defined by a 5-tuple consisting of: (1) an Internet Protocol (IP) address of a sender of the data packet, (2) a port number of the sender, (3) an IP address of a receiver of the data packet, (4) a port number of the receiver, and (5) a network protocol.

In the scenario 100 shown in FIG. 1, the data packets for the app 116, which travel from the client device 102 to the service NN 110, belong to a flow 122 (or from the service NN 110 to the client device 102), data packets for the app 118, which travel from the client device 102 to the service NN 112, belong to a flow 124 (or from the service NN 112 to the client device 102), and data packets for the app 120, which travel from the client device 102 to the service NN 114, belong to a flow 126 (or from the service NN 114 to the client device 102).

In some embodiments, dynamic QoS control over a wireless network may be provided for an app. For example, in the scenario 100, the dynamic QoS control over the wireless network 104 may be provided for the apps 116, 118, and 120. Here, providing QoS control for an app means that specific wireless network configurations corresponding to a certain level of QoS (a.k.a., “QoS level”) are applied to a flow of the wireless network 104 corresponding to the app. Here, examples of the wireless network configurations include network latency, jitter, bandwidth, or error guarantees. Thus, in one example, QoS control may be provided to the packets that belong to flows 122, 124, and 126 as shown in Table 1 provided below:

TABLE 1

| | | | | | |
|---|---|---|---|---|---|
| Flow 122 | QoS level #1 | Network latency #1 | Jitter #1 | Bandwidth #1 | Error guarantee #1 |
| Flow 124 | QoS level #1 | Network latency #1 | Jitter #1 | Bandwidth #1 | Error guarantee #1 |
| Flow 126 | QoS level #2 | Network latency #2 | Jitter #2 | Bandwidth #2 | Error guarantee #2 |

As shown in the Table 1 provided above, in the above example, the data packets for the app 116 and the app 118 (corresponding to the flows 122 and 124) are given the QoS level #1, and the data packets for the app 120 (corresponding to the flow 126) are given the QoS level #2.

One way of applying QoS control for an app is by determining a destination address of a data packet for the app and applying a QoS control to a flow corresponding to the determined destination address. For example, the client device 102 may determine that the destination address of a data packet that is to be sent out from the client device 102 is same as the IP address of the service NN 110, and a traffic policy rule that the client device 102 has may indicate that a data packet to be sent to the service NN 110 should be given the QoS level #1. Then, the flow for carrying the data packet from the client device 102 to the service NN 110 is configured for the QoS level #1 such that the data packet is given the QoS level #1 treatment (e.g., the network latency is set to be the network latency #1, the network bandwidth is set to be the bandwidth #1, etc.).

However, in some scenarios, it is difficult to determine the destination address of a data packet. For example, there may be a scenario where an app running on the client device 102 is associated with multiple servers (e.g., servers #1 and #2), and on the service side a dynamic selection mechanism determines which server to actually provide the service only when a service request from the client device arrives. In such scenario, it is difficult for the client device 102 to predict the correct destination address of the data packet (e.g., the client device 102 wouldn't know whether to send the data packet to the server #1 or the server #2) in advance.

In order to solve the above problems, in some embodiments of this disclosure, an overlay (a.k.a., a tunnel) and an overlay NN (e.g., an overlay gateway (a.k.a., a “tunnel gateway”)) are provided. The concept of the overlay is as follows.

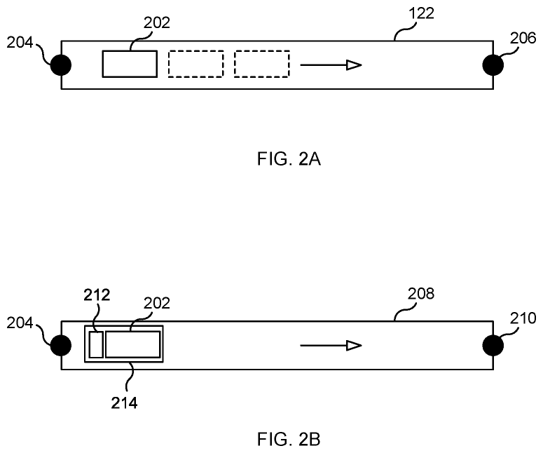

As shown in FIG. 2A, the flow 122 for the app 116 may be defined by a data entry point 204 and a data exit point 206. Here, the data entry point 204 may correspond to the IP address and the port number of the client device 102, and the data exit point 206 may correspond to the IP address and the port number of the service NN 110 which provides a service for the app 116. As discussed above, to apply the QoS control to the flow 122, the information about the data exit point 206 (i.e., the destination of the data packet 202) may need to be determined, but such information may not be always available at the client device 102.

Thus, as shown in FIG. 2B, in some embodiments, an overlay 208 (a.k.a., tunnel 208) is provided. Like the flow 122, the overlay 208 may be defined by a data entry point (i.e., the data entry point 204) and a data exit point. The difference between the flow 122 and the overlay 208 is that, in the overlay 208, the data exit point may correspond to the IP address and the port number of an overlay NN (not the service NN 110).

The data packet 202 that is subject to a specific QoS control can be configured to always “go through” the overlay 208 such that the destination address of this data packet (i.e., the IP address and the port number of the overlay NN) is always known to the client device 102, and thus appropriate QoS control treatment can be applied to the data packet 202. For example, in some embodiments, the data packet 202 (e.g., an IP protocol data unit (PDU) that encapsulates a transport layer PDU that encapsulates an application layer PDU) may be encapsulated into another data packet 214, such as another IP PDU. The data packet 214 may include a payload portion containing data packet 202 and a header 212 which includes: a source address field containing the IP address of client device 102 and a destination address field containing the IP address of overlay NN. Additionally, header 212 may include a protocol field containing information indicating the transport protocol supported by the overlay 208.

Even though, in FIG. 2B, the overlay mechanism is explained using IP packet encapsulation, the overlay mechanisms described in this disclosure can work with any overlay technology or even without requiring encapsulating traffic inside an overlay. There are several different overlay technologies that can be used for this purpose.

Examples of virtual private network (VPN) overlays that use encryption include IPSec, OpenVPN, WireGuard, and example of overlays that do not require encryption/decryption include GRE, VxLAN, IP-in-IP tunnels, etc. Using a non-encrypted overlay enables CSPs to still retain visibility to application data transported within the overlay. If the network provides other ways to match traffic for QoS levels, this can be supported by a similar mechanism.

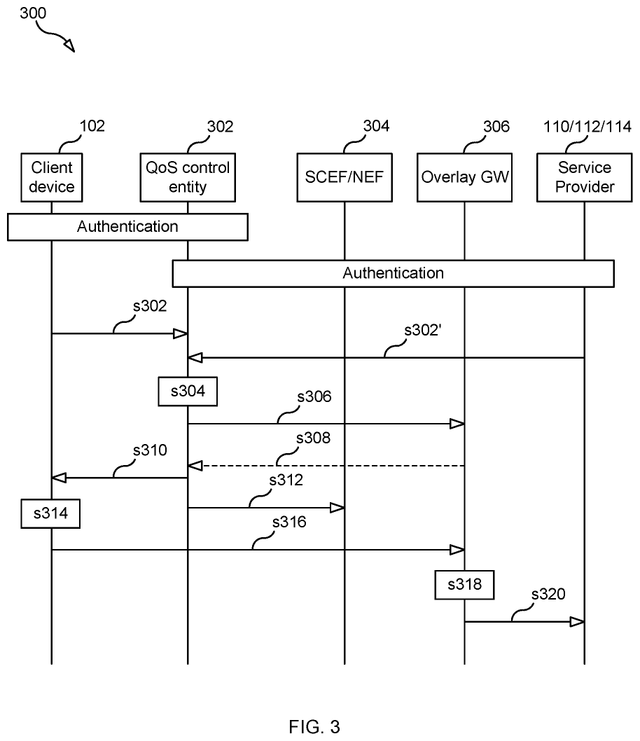

FIG. 3 shows a process 300 for performing dynamic QoS control, according to some embodiments. The process 300 may begin with step s302.

The step s302 comprises the client device 102 transmitting to a QoS control entity 302 a request for a certain QoS level. The request may be a request for configuring an overlay for using a particular app's service at the certain QoS level or a request for configuring an overlay for using services of more than one app (or services of all apps running on the client device 102) at the certain QoS level. The request may be an initial request for a certain QoS level or an update request to change an existing QoS level from a first level to a second level.

The request in step s302 may include a client device identifier (ID) identifying the client device 102 and a QoS level indicator (e.g., a QoS Class identifier (QCI)) indicating the requested certain QoS level. In case the request is a request for configuring an overlay for using a particular app's service at the certain QoS level, the request may include an app ID identifying the app for which the QoS level is requested. Similarly, in case the request is a request for configuring an overlay for using services of more than one app at the certain QoS level, the request may include multiple app IDs identifying the apps for which the QoS level is requested. On the other hand, in case the request is a request for configuring an overlay for using services of all apps running on the client device 102 at the certain QoS level, the request may not need to include any app ID. Note that, in some embodiments, prior to the step s302, the QoS control entity 302 may authenticate the client device 102 first. If the overlay is to be set up with encryption and other security features, additional client device credentials such as its public key and certificate are also provided in request s302.

After receiving the request in step s302, in step s304, the QoS control entity 302 may check the client device 102's policy (which may be stored in the QoS control entity 302 or may be stored outside of the QoS control entity 302) to see if the requested QoS level is permitted under the client device 102's policy and/or if any overlay NN (e.g., an overlay gateway) is configured for the client device 102 and the requested QoS level. Table 2 provided below shows an example of information included in the client device 102's policy.

TABLE 2

| | | |
|---|---|---|
| Client device ID #1 | Overlay NN #1 | QoS level #1 |
| | Overlay NN #2 | QoS level #2 |
| Client device ID #2 | Overlay NN #3 | QoS level #1 |
| . . . | . . . | . . . |

In the example shown in the Table 2 provided above, in case the request transmitted in step s302 comprises the client device ID #1 and the QoS level #1, in step s304, the QoS control entity 302 may determine that the overlay NN #1 corresponds to the client device ID #1 and the QoS level #1.

On the other hand, in case the request transmitted in step s302 comprises the client device ID #1 and a QoS level #3, there is no overlay NN that corresponds to the client device ID #1 and the QoS level #3. In such case, the QoS control entity 302 may set up (i.e., orchestrate) a new overlay NN for the client device ID #1 and the QoS level #3. Table 3 provided below shows an example of information included in the client policy after the setup.

TABLE 3

| | | |
|---|---|---|
| Client device ID #1 | Overlay NN #1 | QoS level #1 |
| | Overlay NN #2 | QoS level #2 |
| | Overlay NN #4 | QoS level #3 |
| Client device ID #2 | Overlay NN #3 | QoS level #1 |
| . . . | . . . | . . . |

After determining the overlay NN (e.g., overlay GW 306) that corresponds to the client device ID identifying the client device 102 and the requested QoS level, in step s306, the QoS control entity 302 may transmit to the overlay NN 306 a configuration message for configuring the overlay NN 306 to handle data packets transmitted from the client device 102 for the requested QoS level. Via this configuration, the overlay NN 306 can be configured to whitelist data packets travelled via an overlay corresponding to overlay NN 306. The overlay NN 306 may be configured in the CSP edge cloud or somewhere outside of the CSP network (i.e., the wireless network 104) (e.g., a public cloud or a service provider cloud). If the overlay is to be set up with encryption and other security features, additional client device credentials such as its public key and certificate are also provided in request s306.

After the configuration, in optional step s308, the overlay NN 306 may transmit to the QoS control entity 302 an optional acknowledgement message indicating that the overlay NN 306 has been configured.

In step s310, the QoS control entity 302 may transmit to the client device 102 a response to the request transmitted in step s302. In case the request in step s302 is accepted by the QoS control entity 302, the response may include overlay information of the configured overlay. The overlay information may comprise one or more of: an internet protocol (IP) address of the client device 102, a port number of the client device 102, an IP address of the overlay NN 306, a port number of the overlay NN 306, and a network protocol selected for the overlay. If the overlay is to be set up with encryption and other security features, additional credentials of the overlay NN 306 such as its public key and certificate are also provided in request s310. Note that, in this disclosure, configuring an overlay may mean setting up the overlay for the first time (e.g., determining the 5-tuple information of the overlay and allowing the overlay to be used for carrying certain data packets) and/or changing the configurations (i.e., reconfiguring) of the existing overlay (e.g., to allow the overlay to be used for carrying other data packets).

In addition to performing step s310, after performing steps s306 and/or s308, step s312 may be performed. Step s312 comprises the QoS control entity 302 creating or configuring a packet filter (e.g., traffic flow template (TFT)) that matches the overlay information (e.g., the 5-tuples of the configured overlay) and transmitting packet filter (PF) information indicating the configured packet filter to the wireless network 104. More specifically, in some embodiments, the QoS control entity 302 may request a dedicated bearer to be set up with the request QoS configuration for the application, and transmit the PF information to exposure servicing entities such as service capability exposure function (SCEF)/network exposure function (NEF) 304 in the wireless network 104 via T8 interface. The PF information received by the wireless network 104 is further configured into both the client device 102 and the CSP network 106 so that IP packets fitting the filter will be transmitted on the newly requested dedicated bearer to receive the requested QoS treatment.

After receiving the response in step s310, in step s314, the client device 102 encapsulates a data packet (e.g., 202) subject to a certain QoS treatment, thereby generating an encapsulated data packet (e.g., 214). As explained with respect to FIG. 2B, the encapsulated data packet includes the original data packet to be sent and the overlay information received in step s310.

In step s316, the client device 102 transmits the encapsulated data packet (e.g., 214), which is routed to the overlay NN 306. Here, the routing of the encapsulated data packet to the overlay may rely on routing tables and mechanisms such as traffic steering and iptables.

In some embodiments, the overlay NN 306 may be the same for all overlays the client device 102 is using, thereby allowing the same IP address (i.e., the IP address of the overlay NN 306) to be used even if data packets are routed over a different overlay as a consequence of changing the QoS level.

Upon receiving the encapsulated data packet (e.g., 214), in step s318, the overlay NN 306 may decapsulate the encapsulated data packet, thereby obtaining the original data packet (e.g., 202). In step s320, the overlay NN 306 may transmit the original data packet to the original destination (e.g., the service NN 110, 112, or 114).

As discussed above with respect to step s302, in some embodiments, the request for the certain QoS level is transmitted from the client device 102. However, in other embodiments, the request may be transmitted from the service NN 110/112/114, as shown in step s302′. In such embodiments, prior to the step s302′, the QoS control entity 302 may authenticate the service NN 110/112/114 first. Also, in these embodiments, in step s304, the QoS control entity 302 may check the service provider's policy to see if the requested QoS level is permitted under the service provider's policy (instead of checking whether the requested QoS level is permitted under the client device 102's policy).

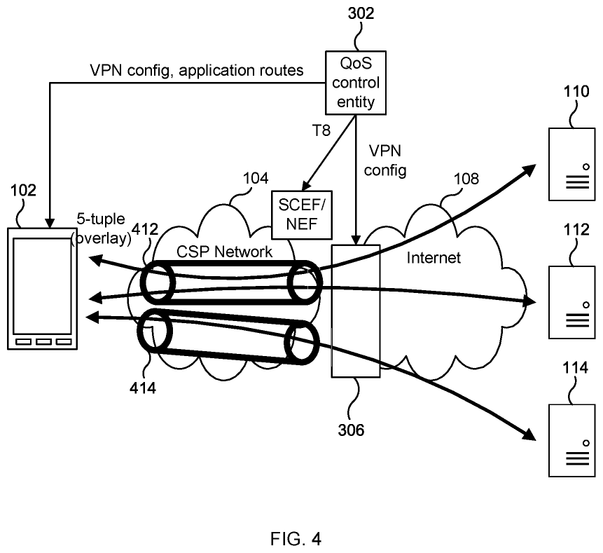

FIGS. 4-6 show different configurations of overlays, according to some embodiments.

In FIG. 4, two overlays 412 and 414 are configured between the client device 102 and the overlay NN 306. The overlay 412 is associated with a first QCI (e.g., QCI6) that provides non-guaranteed bitrate bearer (GBR) and slightly elevated QoS preference within CSP network as compared to best effort traffic on another QCI (e.g., QCI9). On the contrary, the overlay 414 is configured to carry data packets that the client device 102 or the QoS control entity 302 wants to guarantee bitrate during application usage. This overlay may be configured to be on a guaranteed bitrate bearer (GBR) bearer that uses a QCI (e.g., QCI2) which provides better latency, jitter, bandwidth and error guarantees. In addition to the data packets transmitted via the overlays 412 and 414, there may be other application data packets that are not subject to the QoS control treatment. Such data packets (not illustrated) may be routed normally (i.e., without going through the overlays 412 and 414).

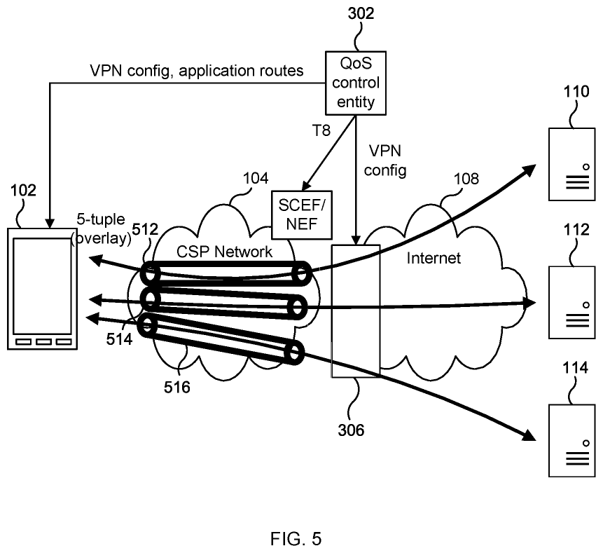

In FIG. 5, three overlays 512, 514, and 516 are configured between the client device 102 and the overlay NN 306. The overlay 512 is for carrying data packets for a first app that is associated with a first QoS level, the overlay 514 is for carrying data packets for a second app that is associated with a second QoS level, and the overlay 516 is for carrying data packets for a third app that is associated with a third QoS level. This configuration allows that the QoS level for data packets of each application can be controlled independently from each other. The QoS control mechanism may provide the client device 102 or the service providers ways to define which apps need to be mapped to the QoS control mechanism.

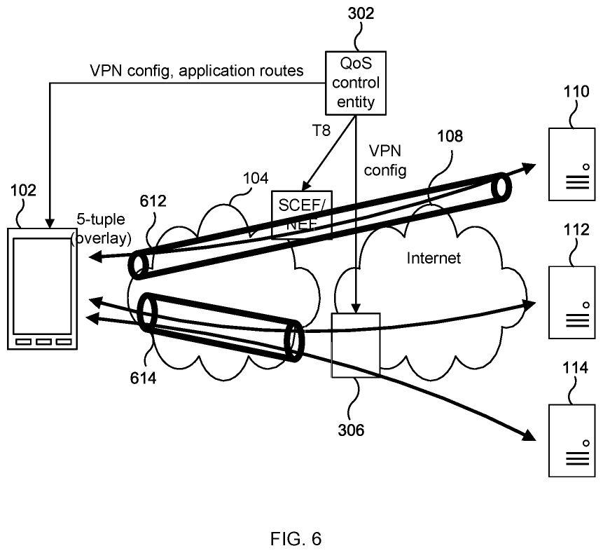

In FIG. 6, an overlay 612 is configured between the client device 102 and the service NN 110, and an overlay 614 is configured between the client device 102 and the overlay NN 306. FIG. 6 depicts the situation where the service NN 110 is also capable of performing as an overlay NN and hence the overlay is established between device 102 and server 110 without the need for a separate overlay NN. Exemplary applications of this configuration include peer-to-peer real-time communication (e.g., audio/video calls).

According to some embodiments, the QoS control entity 302 may have policies that enforce how the client device 102 can use the QoS mechanism. These policies can be agreed upon with the CSP (i.e., the operator of the wireless network 104) such that the CSP still has control over the usage of the wireless network 104. The policies may provide a way to monetize different levels of expected QoS for different users (e.g., different client devices). In addition to creating policies based on the CSP, the QoS control entity 302 may provide an interface for service providers to issue their policies and expectations on QoS levels for the client devices connecting to their services. In addition, this provides a way to terminate the overlay inside the service provider premises by orchestrating per client GW function on their side and providing the configuration information to CSP or by exposing orchestration application programming interfaces (APIs) for QoS Control function, in order for the QoS control entity 302 to orchestrate the GW functions on demand. The orchestrated overlay is once again configured to receive expected QoS treatment within the CSP network, by configuring the agreed TFT rules through the T8 interface. In addition, the client device is instructed to route application traffic for this service provider via this overlay.

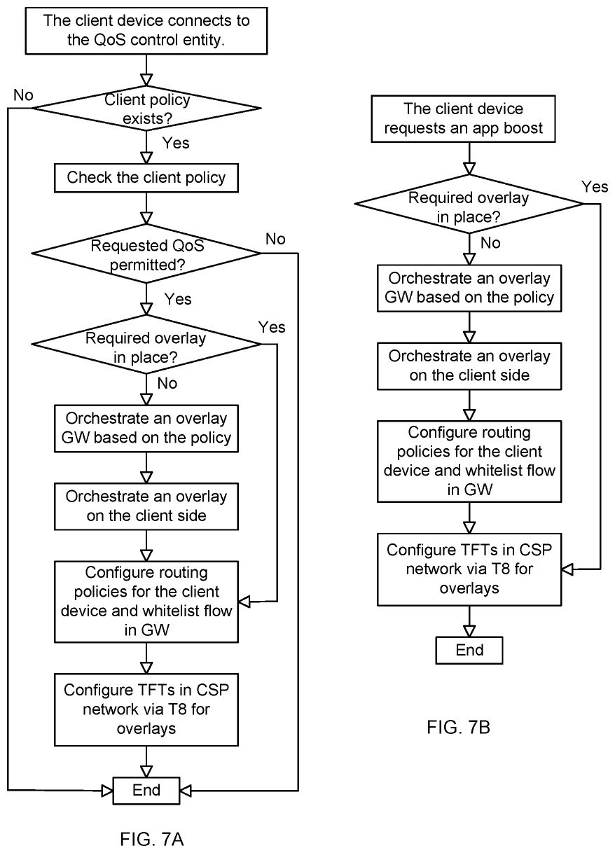

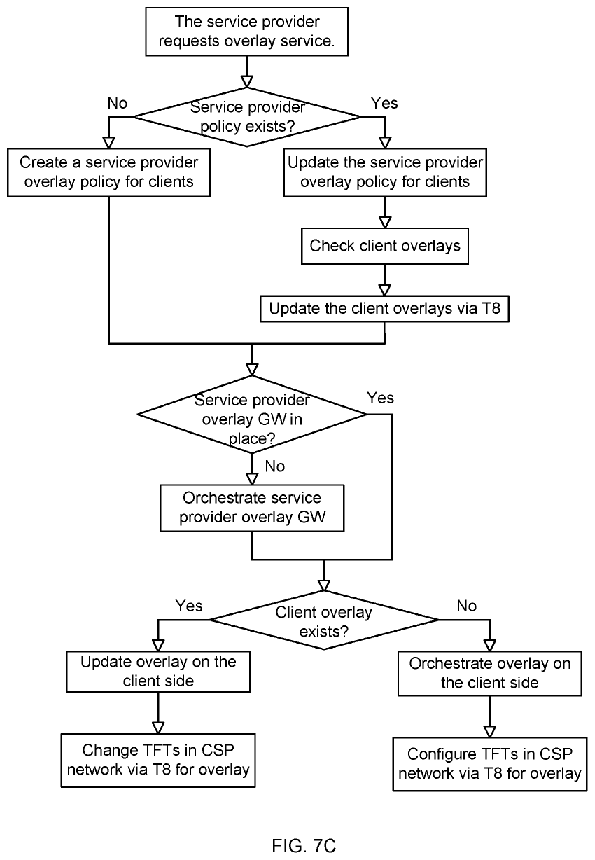

FIG. 7A shows a flow chart summarizing the process 300 shown in FIG. 3. As shown in FIG. 7A, after the client device 102 connects to the QoS control entity 302, the client device 102 may send to the QoS control entity 302 a request for a certain QoS level. Then, the QoS control entity 302 may check the client device 102's overlay policy. If there is no overlay policy for the client device 102, the process may end. On the other hand, if there is an overlay policy for the client device 102, the QoS control entity 302 may check whether the requested QoS level is permitted for the client device 102 under the policy. If the requested QoS level is permitted for the client device 102 under the policy, the QoS control entity 302 may check whether the overlay for providing the requested QoS level is in place. If not, the QoS control entity 302 may trigger orchestrating an overlay gateway based on the client device 102's policy and orchestrating the overlay on the client device side. After the overlay gateway is orchestrated, the QoS control entity 302 may configure routing policies for the client device 102 and whitelist corresponding data flow in the overlay gateway. Then the QoS control entity 302 may trigger configuring TFTs in the CSP network for the overlay(s) via the T8 interface. On the other hand, if the QoS control entity 302 determines that the overlay for providing the requested QoS level is in place, the QoS control entity 302 may just configure the routing policies, whitelist the corresponding data flow, and configure the TFTs (without the orchestrations). As shown in FIG. 7A, in case there is no existing client policy or in case the requested QoS is not permitted under the existing client policy, the process may end. But, in some embodiments, in case there is no existing client policy or in case the requested QoS is not permitted under the existing client policy, the process may revert back to the step of checking whether a client policy exists or to the step of checking whether the requested QoS is permitted under the existing client policy.

In case the client device 102 requests for its QoS level to be increased to a particular QoS level, the process shown in FIG. 7B may be performed. As shown in FIG. 7B, the QoS control entity 302 may first check if the required overlay for providing the requested QoS level is in place. If not, the QoS control entity 302 may trigger orchestrating an overlay gateway based on the client device 102's policy and orchestrating the overlay on the client device side. After the overlay gateway is orchestrated, the QoS control entity 302 may configure routing policies for the client device 102 and whitelist the corresponding data flow in the gateway. Then the QoS control entity 302 may trigger changing TFTs in the CSP network for the overlay(s) via the T8 interface. On the other hand, if the QoS control entity 302 determines that the required overlay for providing the requested QoS level is in place, the QoS control entity 302 may just configure the TFTs (without the overlay orchestrations).

In case the service provider requests for an overlay service, the process shown in FIG. 7C may be performed. As shown in FIG. 7C, the QoS control entity 302 may first check if there is a service provider overlay policy for the service provider. If there is no policy, the QoS control entity 302 may create a service provider overlay policy for client devices. On the other hand, if there is a policy, the QoS control entity 302 may update the service provider overlay policy. The QoS control entity 302 may also check existing overlays. Then, the QoS control entity 302 may update the overlay via the T8 interface. Then, the QoS control entity 302 may check if a service provider overlay gateway is in place. If not, the QoS control entity 302 may trigger orchestrating a service provider overlay gateway. Then the QoS control entity 302 may check if the overlay exists for the requested QoS level. If yes, then the QoS control entity 302 may update the overlay on the client device side and change TFTs in the CSP network for the overlay via the T8 interface. If no, then the QoS control entity 302 may orchestrate an overlay on the client device side and configure TFTs in the CSP network for overlays via the T8 interface.

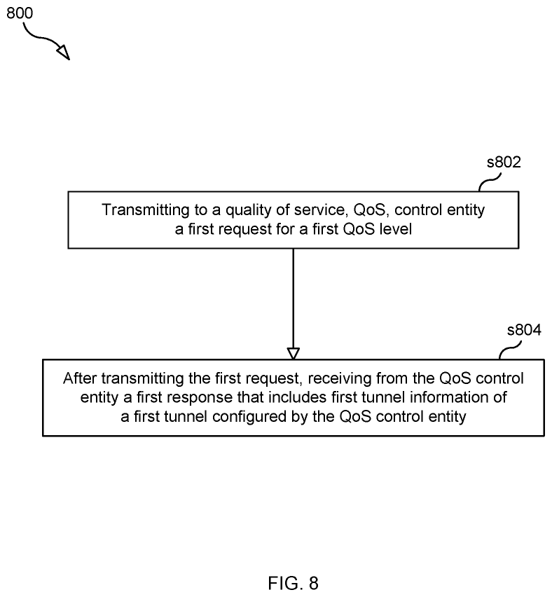

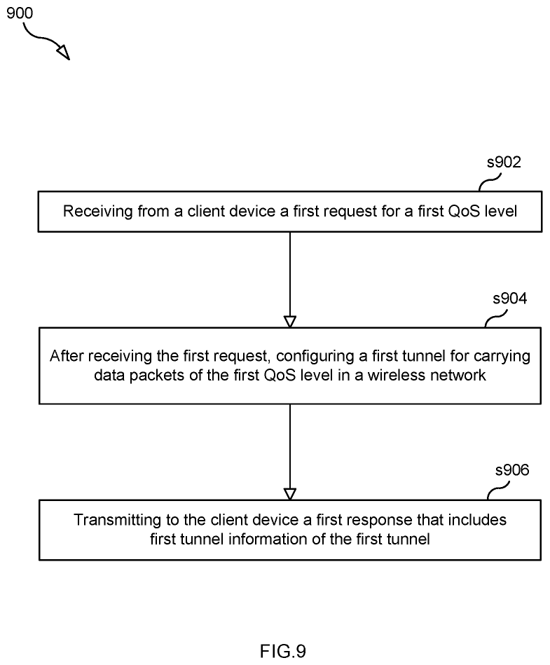

FIG. 8 shows a process 800 performed by the client device 102 according to some embodiments. The process 800 may begin with step s802. The step s802 comprises transmitting to a quality of service, QoS, control entity a first request for a first QoS level. Step s804 comprises, after transmitting the first request, receiving (s804) from the QoS control entity a first response that includes first tunnel information of a first tunnel configured by the QoS control entity, wherein the first tunnel is for carrying data packets of the first QoS level in a wireless network.

In some embodiments, the first request comprises one or more of: a client device identifier, ID, identifying the client device, or a first QoS level indicator indicating the first QoS level.

In some embodiments, (i) the first request is a request for configuring a tunnel for providing multiple applications' services at the first QoS level, or (ii) the first request is a request for configuring a tunnel for providing a first application's service at the first QoS level, further wherein the first request comprises a first application ID identifying the first application.

In some embodiments, the first tunnel is for carrying data packets of the first QoS level between the client device and a tunnel gateway.

In some embodiments, the first application's service is configured to be provided to the client device via a service server or the multiple applications' services are configured to be provided to the client device via multiple service servers, and the service server or any one of the multiple service servers is different from the tunnel gateway.

In some embodiments, the first tunnel information comprises one or more of: an internet protocol, IP, address of the client device, a port number of the client device, an IP address of the tunnel gateway, a port number of the tunnel gateway, and/or a network protocol selected for the first tunnel.

In some embodiments, the process 800 comprises transmitting to the QoS control entity a second request for a second QoS level that is different from the first QoS level; after transmitting the second request, receiving from the QoS control entity a second response that includes second tunnel information of a second tunnel configured by the QoS control entity, wherein the second tunnel is for carrying data packets of the second QoS level in the wireless network.

In some embodiments, the first request is a request for configuring a tunnel for providing the first application's service at the first QoS level, the first tunnel is for carrying data packets of the first application at the first QoS level, and the process 800 comprises: transmitting to the QoS control entity a second request for configuring a tunnel for providing a second application's service at the first QoS level; after transmitting the second request, receiving from the QoS control entity a second response that includes the first tunnel information of the first tunnel configured by the QoS control entity, wherein the first tunnel is also for carrying data packets of the second application at the first QoS level.

In some embodiments, the process 800 comprises obtaining traffic policy information indicating a traffic policy, wherein the traffic policy information indicates that a data packet associated with the first QoS level should be transmitted to the tunnel gateway.

In some embodiments, the process 800 comprises obtaining a data packet that is to be transmitted to a service server; inspecting the data packet to be transmitted, thereby determining that the data packet is to be transmitted at the first QoS level; and encapsulating the data packet to be transmitted, thereby generating an encapsulated data packet, wherein the encapsulated data packet comprises an IP header comprising a destination address field containing an IP address of the tunnel gateway and a destination port field containing a port number of the tunnel gateway.

In some embodiments, the wireless network is managed by a network node, and the process 800 comprises transmitting the first tunnel information to the network node.

FIG. 9 shows a process 900 performed by the QoS control entity 302 according to some embodiments. The process 900 may begin with step s902. The step s902 comprises receiving from a client device a first request for a first QoS level. Step s904 comprises after receiving the first request, configuring a first tunnel for carrying data packets of the first QoS level in a wireless network. Step s906 comprises transmitting to the client device a first response that includes first tunnel information of the first tunnel.

In some embodiments, the first request comprises one or more of: a client device identifier, ID, identifying the client device, or a first QoS level indicator indicating the first QoS level.

In some embodiments, (i) the first request is a request for configuring a tunnel for providing multiple applications' services at the first QoS level, or (ii) the first request is a request for configuring a tunnel for providing a first application's service at the first QoS level, further wherein the first request comprises a first application ID identifying the first application.

In some embodiments, the first tunnel is for carrying data packets of the first QoS level between the client device and a tunnel gateway.

In some embodiments, the first application's service is configured to be provided to the client device via a service server or the multiple applications' services are configured to be provided to the client device via multiple service servers, and the service server or any one of the multiple service servers is different from the tunnel gateway.

In some embodiments, the first tunnel information comprises any one or more of: an internet protocol, IP, address of the client device, a port number of the client device, an IP address of the tunnel gateway, a port number of the tunnel gateway, and a network protocol selected for the first tunnel.

In some embodiments, the process 900 comprises receiving from the client device a second request for a second QoS level that is different from the first QoS level; after receiving the second request, configuring a second tunnel for carrying data packets of the second QoS level in the wireless network; and transmitting to the client device a second response that includes second tunnel information of the second tunnel.

In some embodiments, the first request is a request for configuring a tunnel for providing the first application's service at the first QoS level, the first tunnel is for carrying data packets of the first application at the first QoS level, and the process 900 comprises: receiving from the client device a second request for configuring a tunnel for providing a second application's service at the first QoS level; after receiving the second request, configuring the first tunnel for carrying data packets of the first QoS level in the wireless network; and transmitting to the client device a second response that includes the first tunnel information of the first tunnel.

In some embodiments, the process 900 comprises, after receiving the first request, determining that the tunnel gateway is available for handling data packets of the first QoS level or configuring the tunnel gateway such that the tunnel gateway can handle data packets of the first QoS level.

In some embodiments, the process 900 comprises, after determining that the tunnel gateway is available for handling data packets of the first QoS level or configuring the tunnel gateway such that the tunnel gateway can handle data packets of the first QoS level, creating a traffic policy; and transmitting to the client device traffic policy information indicating the traffic policy, wherein the traffic policy information indicates that a data packet associated with the first QoS level should be transmitted to the tunnel gateway.

In some embodiments, the wireless network is managed by a network node, and the method comprises transmitting the first tunnel information to the network node.

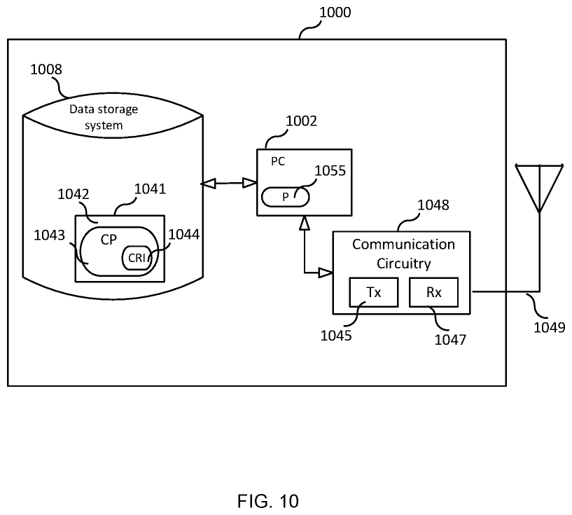

FIG. 10 is a block diagram of the client device 102, according to some embodiments. As shown in FIG. 10, the client device 102 may comprise: processing circuitry (PC) 1002, which may include one or more processors (P) 1055 (e.g., one or more general purpose microprocessors and/or one or more other processors, such as an application specific integrated circuit (ASIC), field-programmable gate arrays (FPGAs), and the like); communication circuitry 1048, which is coupled to an antenna arrangement 1049 comprising one or more antennas and which comprises a transmitter (Tx) 1045 and a receiver (Rx) 1047 for enabling the client device 102 to transmit data and receive data (e.g., wirelessly transmit/receive data); and a local storage unit (a.k.a., “data storage system”) 1008, which may include one or more non-volatile storage devices and/or one or more volatile storage devices. In embodiments where PC 1002 includes a programmable processor, a computer program product (CPP) 1041 may be provided. CPP 1041 includes a computer readable medium (CRM) 1042 storing a computer program (CP) 1043 comprising computer readable instructions (CRI) 1044. CRM 1042 may be a non-transitory computer readable medium, such as, magnetic media (e.g., a hard disk), optical media, memory devices (e.g., random access memory, flash memory), and the like. In some embodiments, the CRI 1044 of computer program 1043 is configured such that when executed by PC 1002, the CRI causes the client device 102 to perform steps described herein (e.g., steps described herein with reference to the flow charts). In other embodiments, the client device 102 may be configured to perform steps described herein without the need for code. That is, for example, PC 1002 may consist merely of one or more ASICs. Hence, the features of the embodiments described herein may be implemented in hardware and/or software.

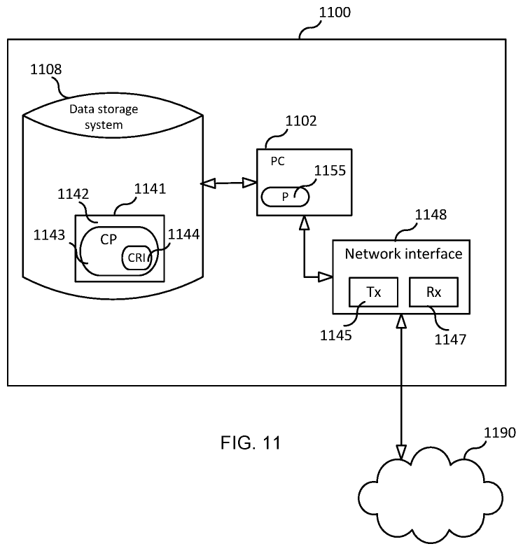

FIG. 11 is a block diagram of an apparatus 1100, according to some embodiments, for implementing the QoS control entity 302, the SCEF/NEF 304, the overlay GW 306, and the service NN 110/112/114. As shown in FIG. 11, apparatus 1100 may comprise: processing circuitry (PC) 1102, which may include one or more processors (P) 1155 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed (i.e., apparatus 1100 may be a distributed computing apparatus); a network interface 1148 comprising a transmitter (Tx) 1145 and a receiver (Rx) 1147 for enabling apparatus 1100 to transmit data to and receive data from other nodes connected to a network 1190 (e.g., an Internet Protocol (IP) network) to which network interface 1148 is connected (directly or indirectly) (e.g., network interface 1148 may be wirelessly connected to the network 1190, in which case network interface 1148 is connected to an antenna arrangement); and a local storage unit (a.k.a., “data storage system”) 1108, which may include one or more non-volatile storage devices and/or one or more volatile storage devices. In embodiments where PC 1102 includes a programmable processor, a computer program product (CPP) 1141 may be provided. CPP 1141 includes a computer readable medium (CRM) 1142 storing a computer program (CP) 1143 comprising computer readable instructions (CRI) 1144. CRM 1142 may be a non-transitory computer readable medium, such as, magnetic media (e.g., a hard disk), optical media, memory devices (e.g., random access memory, flash memory), and the like. In some embodiments, the CRI 1144 of computer program 1143 is configured such that when executed by PC 1102, the CRI causes apparatus 1100 to perform steps described herein (e.g., steps described herein with reference to the flow charts). In other embodiments, apparatus 1100 may be configured to perform steps described herein without the need for code. That is, for example, PC 1102 may consist merely of one or more ASICs. Hence, the features of the embodiments described herein may be implemented in hardware and/or software.

### CONCLUSION

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

As used herein transmitting a message “to” or “toward” an intended recipient encompasses transmitting the message directly to the intended recipient or transmitting the message indirectly to the intended recipient (i.e., one or more other nodes are used to relay the message from the source node to the intended recipient). Likewise, as used herein receiving a message “from” a sender encompasses receiving the message directly from the sender or indirectly from the sender (i.e., one or more nodes are used to relay the message from the sender to the receiving node). Further, as used herein “a” means “at least one” or “one or more.”

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method performed by a client device, the method comprising:
transmitting to a quality of service (QoS) control entity a first request for a first QoS level; and
after transmitting the first request, receiving from the QoS control entity a first response that includes first tunnel information of a first tunnel configured by the QoS control entity, wherein
the first tunnel is for carrying data packets of the first QoS level in a wireless network.

2. The method of claim 1, wherein the first request comprises:
a client device identifier (ID) identifying the client device, and/or
a first QoS level indicator indicating the first QoS level.

3. The method of claim 1, wherein
(i) the first request is a request for configuring a tunnel for providing multiple applications' services at the first QoS level, or
(ii) the first request is a request for configuring a tunnel for providing a first application's service at the first QoS level, further wherein the first request comprises a first application ID identifying the first application.

4. (canceled)

5. The method of claim 1, wherein
the first tunnel is for carrying data packets of the first QoS level between the client device and a tunnel gateway,
the first application's service is configured to be provided to the client device via a service server or the multiple applications' services are configured to be provided to the client device via multiple service servers, and
the service server or any one of the multiple service servers is different from the tunnel gateway.

6. The method of claim 1, wherein
the first tunnel is for carrying data packets of the first QoS level between the client device and a tunnel gateway, and
the first tunnel information comprises one or more of:
an internet protocol (IP) address of the client device,
a port number of the client device,
an IP address of the tunnel gateway,
a port number of the tunnel gateway, and/or
a network protocol selected for the first tunnel.

7. The method of claim 1, comprising:
transmitting to the QoS control entity a second request for a second QoS level that is different from the first QoS level;
after transmitting the second request, receiving from the QoS control entity a second response that includes second tunnel information of a second tunnel configured by the QoS control entity, wherein
the second tunnel is for carrying data packets of the second QoS level in the wireless network.

8. The method of claim 3, wherein
the first request is a request for configuring a tunnel for providing the first application's service at the first QoS level,
the first tunnel is for carrying data packets of the first application at the first QoS level, and
the method comprises:
transmitting to the QoS control entity a second request for configuring a tunnel for providing a second application's service at the first QoS level;
after transmitting the second request, receiving from the QoS control entity a second response that includes the first tunnel information of the first tunnel configured by the QoS control entity, wherein
the first tunnel is also for carrying data packets of the second application at the first QoS level.

9. (canceled)

10. The method of claim 1, wherein
the first tunnel is for carrying data packets of the first QoS level between the client device and a tunnel gateway,
the method further comprises:
obtaining traffic policy information indicating a traffic policy, wherein the traffic policy information indicates that a data packet associated with the first QoS level should be transmitted to the tunnel gateway
obtaining a data packet that is to be transmitted to a service server;
inspecting the data packet to be transmitted, thereby determining that the data packet is to be transmitted at the first QoS level; and
encapsulating the data packet to be transmitted, thereby generating an encapsulated data packet, wherein the encapsulated data packet comprises an IP header comprising a destination address field containing an IP address of the tunnel gateway and a destination port field containing a port number of the tunnel gateway.

11. The method of claim 1, wherein
the wireless network is managed by a network node, and
the method comprises transmitting the first tunnel information to the network node.

12. A method performed by a quality of service (QoS) control entity, the method comprising:
receiving from a client device a first request for a first QoS level;
after receiving the first request, configuring a first tunnel for carrying data packets of the first QoS level in a wireless network; and
transmitting to the client device a first response that includes first tunnel information of the first tunnel.

13. The method of claim 12, wherein the first request comprises one or more of:
a client device identifier (ID) identifying the client device, or
a first QoS level indicator indicating the first QoS level.

14. The method of claim 12, wherein
(i) the first request is a request for configuring a tunnel for providing multiple applications' services at the first QoS level, or
(ii) the first request is a request for configuring a tunnel for providing a first application's service at the first QoS level, further wherein the first request comprises a first application ID identifying the first application.

15. (canceled)

16. The method of claim 12, wherein
the first tunnel is for carrying data packets of the first QoS level between the client device and a tunnel gateway,
the first application's service is configured to be provided to the client device via a service server or the multiple applications' services are configured to be provided to the client device via multiple service servers, and
the service server or any one of the multiple service servers is different from the tunnel gateway.

17. The method of claim 12, wherein
the first tunnel is for carrying data packets of the first QoS level between the client device and a tunnel gateway, and
the first tunnel information comprises:
an internet protocol (IP) address of the client device,
a port number of the client device,
an IP address of the tunnel gateway,
a port number of the tunnel gateway, and/or
a network protocol selected for the first tunnel.

18. The method of claim 12, further comprising:
receiving from the client device a second request for a second QoS level that is different from the first QoS level;
after receiving the second request, configuring a second tunnel for carrying data packets of the second QoS level in the wireless network; and
transmitting to the client device a second response that includes second tunnel information of the second tunnel.

19. The method of claim 14, wherein
the first request is a request for configuring a tunnel for providing the first application's service at the first QoS level,
the first tunnel is for carrying data packets of the first application at the first QoS level, and
the method comprises:
receiving from the client device a second request for configuring a tunnel for providing a second application's service at the first QoS level;
after receiving the second request, configuring the first tunnel for carrying data packets of the first QoS level in the wireless network; and
transmitting to the client device a second response that includes the first tunnel information of the first tunnel.

20. The method of claim 12, wherein
the method further comprises, after receiving the first request, determining that the tunnel gateway is available for handling data packets of the first QoS level or configuring the tunnel gateway such that the tunnel gateway can handle data packets of the first QoS level.

21. The method of claim 20, further comprising:
after determining that the tunnel gateway is available for handling data packets of the first QoS level or configuring the tunnel gateway such that the tunnel gateway can handle data packets of the first QoS level, creating a traffic policy; and
transmitting to the client device traffic policy information indicating the traffic policy, wherein
the traffic policy information indicates that a data packet associated with the first QoS level should be transmitted to the tunnel gateway.

22-23. (canceled)

24. A client device, the client device being configured to:
transmit to a quality of servicer (QoS) control entity a first request for a first QoS level; and
after transmitting the first request, receive from the QoS control entity a first response that includes first tunnel information of a first tunnel configured by the QoS control entity, wherein
the first tunnel is for carrying data packets of the first QoS level in a wireless network.

25. (canceled)

26. A quality of servicer (QoS) control entity, the QoS control entity being configured to:
receive from a client device a first request for a first QoS level;
after receiving the first request, configure a first tunnel for carrying data packets of the first QoS level in a wireless network; and
transmit to the client device a first response that includes first tunnel information of the first tunnel.

27. (canceled)
